(19) United States
(12) Patent Application Publication
(10) Pub. No.: US 2016/0071045 A1
(43) Pub. Date: Mar. 10, 2016

(54) FORECAST PREDICIBILITY AND ACCOUNTABILITY IN CUSTOMER RELATIONSHIP MANAGEMENT (CRM)

(71) Applicant: SugarCRM Inc., Cupertino, CA (US)

(72) Inventors: Majed Itani, San Jose, CA (US); Zac Sprackett, Ottawa (CA)

(21) Appl. No.: 14/479,300

(22) Filed: Sep. 6, 2014

(51) Int. Cl. G06Q 10/06

(52) U.S. Cl. CPC G06Q 10/06375

(57) ABSTRACT

Embodiments of the invention provide a method, system and computer program product for forecast predictability and accountability in a CRM system. In an embodiment of the invention, a method for forecast predictability and accountability in a CRM system includes retrieving into memory of a computer from a database of a CRM system, different CRM records, each of the records indicating closed-won business opportunities and different characteristics of the closed-won business opportunities. The method also includes grouping in the memory the closed-won opportunities according to common characteristic. Total revenues for each grouping of the closed-won opportunities can be computed and it can be determined from the total revenues of each grouping, a characteristic associated with a greatest amount of total revenues compared to groupings of other characteristics. Finally, a higher priority can be assigned in the CRM system to new business opportunities having the determined characteristic.

### BACKGROUND OF THE INVENTION

1. Field of the Invention

The present invention relates to customer relationship management (CRM) computing and more particularly to sales forecasting in a CRM system.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM systems are often used to manage the entire lifecycle of a relationship between a customer and an organization. In this regard, a CRM system is enabled to manage tasks for organizational representatives associated with the targeting and acquisition of a new customer, the fulfillment of a sale to a new customer or an existing customer, and the maintenance of a relationship with an existing customer. Much of the role of the CRM system is to store data documenting the relationship between representatives of an organization and its customers and prospective customers. However, another role of the CRM system is to provide a view to a sales pipeline for a sales manager. Utilizing the view to the sales pipeline, the sales manager can best allocate sales resources to achieve optimal conversion of sales prospects into closed-win opportunities.

### BRIEF SUMMARY OF THE INVENTION

Embodiments of the present invention address deficiencies of the art in respect to sales forecasting in a CRM system and provide a novel and non-obvious method, system and computer program product for forecast predictability and accountability in a CRM system. In an embodiment of the invention, a method for forecast predictability and accountability in a CRM system includes retrieving into memory of a computer from a database of a CRM system, different CRM records, each of the records indicating closed-won business opportunities and different characteristics of the closed-won business opportunities. The method also includes grouping in the memory the closed-won opportunities according to common characteristic. Total revenues for each grouping of the closed-won opportunities can be computed and it can be determined from the total revenues of each grouping, a characteristic associated with a greatest amount of total revenues compared to groupings of other characteristics. Finally, a higher priority can be assigned in the CRM system to new business opportunities having the determined characteristic.

In one aspect of the embodiment, the characteristic is a lead source. In another aspect of the embodiment, the characteristic is an industry for each new business opportunity. In yet another aspect of the embodiment, the characteristic is a range of corporate size for each new business opportunity. Finally, in even yet another aspect of the embodiment, the characteristic is a range of corporate revenues for each new business opportunity.

In another embodiment of the invention, a CRM data processing system is configured for forecast predictability and accountability. The system includes a host computing system that includes at least one computer with memory and at least one processor and a CRM system executing in the memory of the host computing system. The system also includes a data store of CRM data accessible by the CRM system. Finally, the system includes a forecast predictability and accountability module coupled to the CRM system and the data store. The module includes program code enabled upon execution in the memory of the system to retrieve into memory from the data store different CRM records, the records indicating closed-won business opportunities and different characteristics of the closed-won business opportunities, to group in the memory the closed-won opportunities according to common characteristic, to compute total revenues for each grouping of the closed-won opportunities, to determine from the total revenues of each grouping, a characteristic associated with a greatest amount of total revenues compared to groupings of other characteristics and to assign a higher priority in the CRM system to new business opportunities having the determined characteristic.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for forecast predictability and accountability in a CRM system;

FIG. 2 is a schematic illustration of a CRM data processing system configured for forecast predictability and accountability; and,

FIG. 3 is a flow chart illustrating a process for forecast predictability and accountability in a CRM system.

### DETAILED DESCRIPTION OF THE INVENTION

Embodiments of the invention provide for forecast predictability and accountability in a CRM system. In accordance with an embodiment of the invention, a CRM data store can be processed to identify different closed-won opportunities for different customers. The source of a lead from which each closed-won opportunity resulted can be identified and the closed-won opportunities for each source can be grouped together with each source being characterized in terms of either a total number of closed-won opportunities resulting therefrom, or a total amount of revenue resulting therefrom. Thereafter, a set of new opportunities can be analyzed and prioritized based upon the source of each of the new opportunities such that new opportunities stemming from sources known to have resulted in a greater amount of revenue or closed-won opportunities can be prioritized over others of the new opportunities.

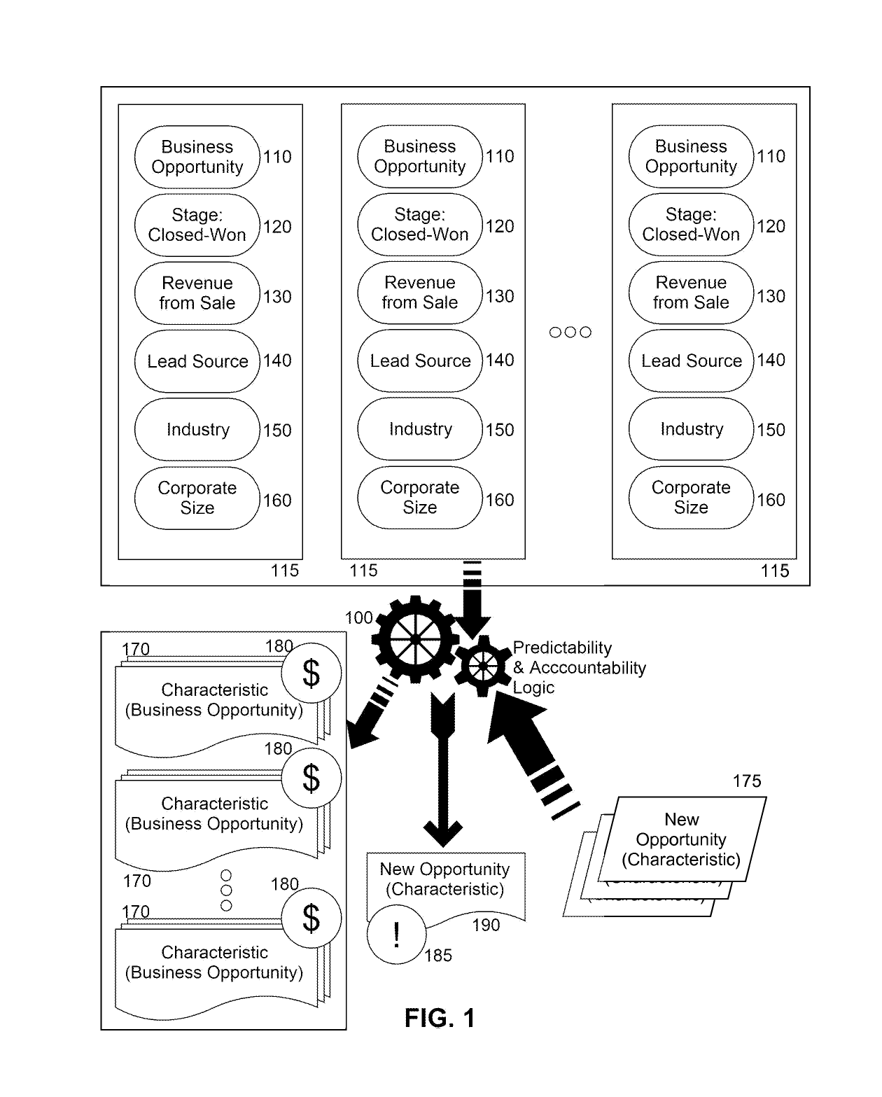

In further illustration, FIG. 1 pictorially shows a process for forecast predictability and accountability in a CRM system. As shown in FIG. 1, a CRM data store of different business opportunity records 115 can be processed to identify different business opportunities 110 previously registered within the CRM system. Those of the business opportunities 110 of a stage in the sales cycle of “closed-won” 120 can be extracted in as much as a “closed-won” stage means that a business opportunity has been completed and has resulted in a sale of a product or service (or both). Revenue data 130 resulting from each of the business opportunities 110 having a stage of closed-won 120 also can be determined as can a lead source record 140 giving rise to the business opportunity 110, as well as an industry record 150 and a corporate size or total corporate revenues record 160.

Predictability and accountability logic 100 can process the extracted records so as to create different groupings 170 of the business opportunities 110. Each of the groupings can include those of the business opportunities 110 sharing a common characteristic, for example a common lead source, a common industry, or a common corporate size, to name but a few examples. A total amount of revenue value 180 further can be computed for each of the groupings 170 so that those of the business opportunities 110 of a particular characteristic resulting in the greatest amount of revenue can be identified. Thereafter, the predictability and accountability logic 100 can determine a characteristic for each new business opportunity 175 and can determine which of the groupings 170 corresponds to the new business opportunity 175. Consequently, a particular new business opportunity 190 selected from amongst the new business opportunities 175 that has associated therewith a grouping 170 of the highest computed revenue 180 can be assigned a priority 185 for visual emphasis in a user interface to the CRM system.

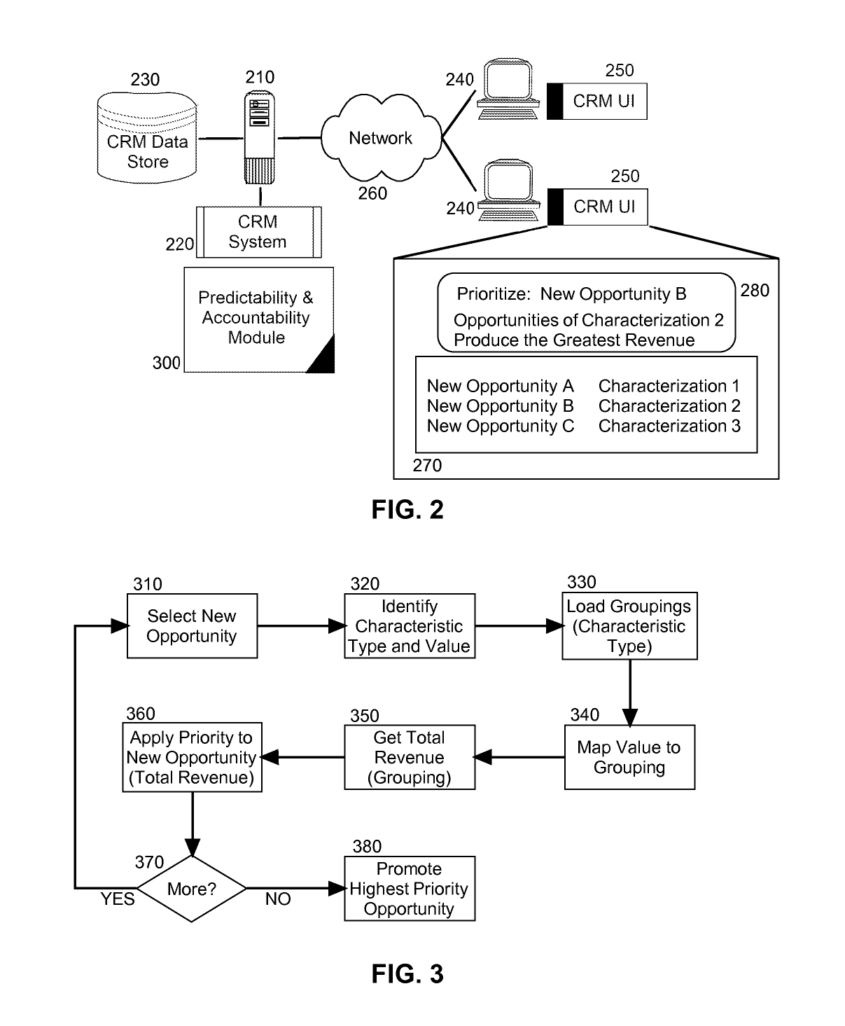

The process described in connection with FIG. 1 can be implemented within a CRM data processing system. In further illustration, FIG. 2 schematically shows a CRM data processing system configured for forecast predictability and accountability. The system can include a host computing system 210 that can include one or more computers each with memory and at least one processor. The host computing system 210 can support the execution of a CRM system 220 managing CRM data in a CRM data store 230, and managing access thereto from over a computer communications network 260 by different end users through respectively different CRM user interfaces 250 provided by corresponding client computing devices 240.

A predictability and accountability module 300 can be coupled to the CRM system 220. The module 300 can include program code that when executes in the memory of the host computing system 210 by a processor of the host computing system 210 is enabled to produce groupings of different past business opportunities according to commonly shared values for a selected characteristic. The program code is further enabled to compute a total amount of revenue associated with each of the groupings. The program code yet further can be enabled to compare a value of the characteristic of each of a set of new business opportunities in the CRM system 220 to the groupings in order to identify those of the new business opportunities associated with a grouping of a highest total revenue.

In this way, the program code of the module 300 can be enabled to modify user interface elements 270, 280 of the CRM user interface 250 in order to visually emphasize those of the new business opportunities most likely to produce the greatest sales impact according to a characteristic identified within those of the new business opportunities. For example, a dashlet 280, message box or pop-up window can be generated to specifically call attention to those of the new business opportunities most likely to produce the greatest sales impact. Alternatively, a listing 270 of the new business opportunities can be sorted in accordance with those of the new business opportunities most likely to produce the greatest sales impact.

In yet further illustration of the operation of the predictability and accountability module 300, FIG. 3 is a flow chart illustrating a process for forecast predictability and accountability in a CRM system. Beginning in block 310, a new business opportunity amongst a set of new business opportunities can be selected for processing. In block 320, different types of characteristics and different values of those characteristics can be determined for the selected business opportunity. In block 330, a set of groupings can be loaded into memory in accordance with a particular one of the different types of characteristics, and in block 340 a value of the characteristic can be mapped to a particular one of the groupings in the set of groupings.

Thereafter, in block 350 the total revenue for the mapped grouping can be retrieved and in block 360, a priority can be assigned to the selected business opportunity based upon the total revenue. Subsequently, in decision block 370, if additional business opportunities remain to be processed in the set of new business opportunities, the process can return to block 310. Otherwise, in block 380 the new business opportunity in the set of new business opportunities associated with the greatest total revenues can be promoted to a highest priority in the CRM system. Alternatively, the new business opportunity in the set of new business opportunities associated with a grouping of the greatest number of closed-won opportunities can be promoted to a highest priority in the CRM system.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for forecast predictability and accountability in a customer relationship management (CRM) system, the method comprising:
retrieving into memory of a computer from a database of a CRM system, different CRM records, the records indicating closed-won business opportunities and different characteristics of the closed-won business opportunities;
grouping in the memory the closed-won opportunities according to common characteristic;
computing total revenues for each grouping of the closed-won opportunities;
determining from the total revenues of each grouping, a characteristic associated with a greatest amount of total revenues compared to groupings of other characteristics; and,
assigning a higher priority in the CRM system to new business opportunities having the determined characteristic.

2. The method of claim 1, wherein the characteristic is a lead source.

3. The method of claim 1, further comprising:
additionally computing a total number of the closed-won opportunities associated with each grouping; and,
assigning a higher priority in the CRM system to each new business opportunity stemming from a characteristic of the grouping with a highest number of closed-won opportunities.

4. The method of claim 1, wherein the characteristic is an industry for each new business opportunity.

5. The method of claim 1, wherein the characteristic is a range of corporate size for each new business opportunity.

6. The method of claim 1, wherein the characteristic is a range of corporate revenues for each new business opportunity.

7. A customer relationship management (CRM) data processing system configured for forecast predictability and accountability, the system comprising:
a host computing system comprising at least one computer with memory and at least one processor;
a CRM system executing in the memory of the host computing system;
a data store of CRM data accessible by the CRM system; and,
a forecast predictability and accountability module coupled to the CRM system and the data store, the module comprising program code enabled upon execution in the memory of the system to retrieve into memory from the data store different CRM records, the records indicating closed-won business opportunities and different characteristics of the closed-won business opportunities, to group in the memory the closed-won opportunities according to common characteristic, to compute total revenues for each grouping of the closed-won opportunities, to determine from the total revenues of each grouping, a characteristic associated with a greatest amount of total revenues compared to groupings of other characteristics and to assign a higher priority in the CRM system to new business opportunities having the determined characteristic.

8. The system of claim 7, wherein the characteristic is a lead source.

9. The system of claim 7, wherein the program code is further enabled to additionally compute a total number of the closed-won opportunities associated with each grouping and to assign a higher priority in the CRM system to each new business opportunity stemming from a characteristic of the grouping with a highest number of closed-won opportunities.

10. The system of claim 7, wherein the characteristic is an industry for each new business opportunity.

11. The system of claim 7, wherein the characteristic is a range of corporate size for each new business opportunity.

12. The system of claim 7, wherein the characteristic is a range of corporate revenues for each new business opportunity.

13. A computer program product for forecast predictability and accountability in a customer relationship management (CRM) system, the computer program product comprising a computer readable storage medium having program instructions embodied therewith, the program instructions executable by a device to cause the device to perform a method comprising:
retrieving by the device into memory of a computer from a database of a CRM system, different CRM records, the records indicating closed-won business opportunities and different characteristics of the closed-won business opportunities;
grouping by the device in the memory the closed-won opportunities according to common characteristic;
computing by the device total revenues for each grouping of the closed-won opportunities;
determining by the device from the total revenues of each grouping, a characteristic associated with a greatest amount of total revenues compared to groupings of other characteristics; and,
assigning by the device a higher priority in the CRM system to new business opportunities having the determined characteristic.

14. The computer program product of claim 13, wherein the characteristic is a lead source.

15. The computer program product of claim 13, further comprising:
additionally computing by the device a total number of the closed-won opportunities associated with each grouping; and,
assigning by the device a higher priority in the CRM system to each new business opportunity stemming from a characteristic of the grouping with a highest number of closed-won opportunities.

16. The computer program product of claim 13, wherein the characteristic is an industry for each new business opportunity.

17. The computer program product of claim 13, wherein the characteristic is a range of corporate size for each new business opportunity.

18. The computer program product of claim 13, wherein the characteristic is a range of corporate revenues for each new business opportunity.
